(19) United States
(12) Patent Application Publication
(10) Pub. No.: US 2006/0194152 A1
(43) Pub. Date: Aug. 31, 2006

(54) Infra-red switchable mixture for producing lithographic printing plate

(76) Inventor: Murray Figov, Ra'anana (IL)

Correspondence Address: PATENT LEGAL STAFF, EASTMAN KODAK COMPANY, 343 STATE STREET, ROCHESTER, NY, 14650-2201, US

(21) Appl. No.: 10/543,310

(22) PCT Filed: Dec. 16, 2003
(86) PCT No.: PCT/IL03/01071

§ 371 Date: Jul. 26, 2005

Related U.S. Application Data
(60) Provisional application No. 60/444,182, filed on Feb. 3, 2003.

(51) Int. Cl. G03C 1/76

(52) U.S. Cl. 430/302; 430/270.1

(57) ABSTRACT

Water-based mixtures that can be applied to substrates to produce infra-red sensitive layers with hydrophilic surfaces, which may be switched by image-wise exposure in an infrared imaging plate-setter to give oleophilic printing areas, for producing processless offset lithographic printing plates.

### CROSS-REFERENCE TO RELATED PATENT APPLICATIONS

This patent application claims priority from and is related to U.S. Provisional Patent Application Ser. No. 60/444,182, filed Feb. 3, 2003, this U.S. Provisional Patent Application incorporated by reference in its entirety herein.

### FIELD OF INVENTION

This invention relates to lithographic printing plates which are imaged by switching the exposed areas of the plate surface from hydrophilic to oleophilic properties and which do not need subsequent processing before use as conventional (wet) offset lithographic printing plates.

### BACKGROUND OF THE INVENTION

Offset lithographic printing has remained a most popular method of printing for many years. An important reason for this is the relative ease with which offset lithographic printing plates can be produced. For many years, the most widely used method for plate preparation has been that which utilizes specially prepared masking films through which pre-sensitized printing blanks are selectively hardened or softened (according to the chemistry of the plate) by exposure to ultra violet light. The plate then undergoes a development process, during which the more soluble regions of the plate are washed away using a processing liquid, leaving the remainder of the coating to function as the print areas.

In recent years, various considerations have arisen that point to advantages for modification of hitherto generally accepted practices. With the advent of computers, information for printing is prepared digitally and it has become preferable to use this digital information as directly as possible in plate preparation. One obvious way is to eliminate the masking film. Not only are these films a source of expense, but the most widely used films are based on silver chemistry, whereby the exposure and handling of the film must be in a light excluding environment and where chemical solutions which are unstable, messy and environmentally problematic are used. One answer is to be found in computer-to-plate (CTP) systems whereby plates are imaged with a light source which is modulated directly to correspond to the digital information from the computer. A commercial type of CTP that is now generally available is that based on thermal imaging due to the availability of relatively inexpensive laser sources for infra-red radiation. Such machines have become increasingly popular and now have a significant share of the plate-making market.

A further trend in the printing market should be noted. The number of copies required for any particular printing job is declining. There are various reasons for this. They include the high cost of warehousing, and the trend to more local printing to avoid high postage. This has been termed “distribute and print” as opposed to the former practice of “print and distribute.” Thus there is a growing market for short run printing.

Laser imaging of offset printing blanks is well known. U.S. Pat. No. 4,054,094 to Caddell et al describes such a system. The plate comprises a thin hard hydrophilic coating on a polymer coated on a polymeric or metal base. The laser etches (or ablates) away the layers to expose the base material which is oleophilic. The laser used is a high energy carbon dioxide one—available at the time of filing of the Cadell patent. The patent would not be applicable for use with the modern lower energy, lower costs laser diodes.

U.S. Pat. No. 4,693,958 to Schwartz et al describes a plate whereby the water-soluble coating is hardened by the laser radiation and the unhardened non image areas are washed away to expose a hydrophilic aluminum substrate. The film thickness to be hardened is at least 0.2 microns and here again the energy needed is high.

U.S. Pat. No. 3,511,178 to Curtin introduced a new concept of “driographic” or waterless printing. This uses offset printing plates with ink-repelling surfaces which do not require fount. As this is a concept that will be further referred to within the present application, it is useful and convenient to distinguish between hitherto conventional offset lithographic printing plates and the relatively newer waterless offset lithographic printing plates. The conventional plates will be referred to as “wet” because such plates need a fount solution to be applied to their surface before ink application, during the printing process. Fount solutions are water-based. Hence the term “wet.

U.S. Pat. No. 5,339,737 to Lewis et al describes both wet litho and waterless litho, wherein the upper layer or layers of the plate are ablated away. The upper layer is either oleophobic for waterless plates or hydrophilic for conventional wet process plates. The substrate is oleophilic in both cases.

U.S. Pat. No. 5,353,705 to Lewis et al is based on a technology similar to the previous patent but describes additional layers for secondary partial ablation.

U.S. Pat. No. 5,487,338 to Lewis et al is another patent of the same family but includes reflective layers. Multiple layered plates are expensive to produce and it is more difficult to maintain a consistent standard of quality in manufacture.

U.S. Pat. No. 5,493,971 to Lewis et al describes wet plates with three layers. The top layer is ablated during imaging and the second protective layer is then washed away to reveal hydrophilic aluminum.

In general, where ablation is used for imaging, it is necessary to remove the ablation products. In some cases they may be collected by vacuum, but in general some detritus remains on the plate and must be removed by dry or wet rubbing.

In contrast to ablation, U.S. Pat. No. 5,401,611 to Edwards Sr. et al describes a plate with a very thin silver-based oleophobic layer on top of a hydrophilic layer. Infra red laser radiation converts the oleophilic surface to being hydrophilic. The chemistry involved here is based on silver and the plate manufacturing preparation is complex. This patent represents an early attempt to produce a plate that is processless and where the surface of the plate is switched by imaging radiation from oleophilic to hydrophilic properties. A polymeric surface where the change of water or ink receptive properties under the influence of imaging radiation is now referred to as a switchable polymer and a plethora of patent applications makes manifest the interest in this.

Processless switchable polymer plates or surfaces have several advantages. The elimination of processing shortens the plate-making time and is more economic in saving on purchase of processing equipment and the use and disposal of processing liquids. Such liquids are usually water-based with a high pH and are environmentally problematic in their disposal. In addition, processing chemistry usually shows deterioration over a period of days or weeks as it becomes contaminated with the washed out material from the plates, or loses its efficacy by reaction with carbon dioxide in the air. The processor often requires periodic cleaning as plate sludge accumulates.

Offset printing machines have now been developed that have imaging on-press, where ideally the plate material has no processing or where such processing is very simple. An example of this technology is the Heidelberg Model QMDI-46, manufactured by Heidelberg Druckmaster AG (Germany), which utilizes infrared ablatable waterless plates. Furthermore, Gelbart (U.S. Pat. No. 5,713,287) has proposed the use of the cylinder itself as the plate substitute substrate, whereby a switchable polymer is then sprayed onto the surface, imaged and then used as a printing form. After printing, the coating is removed and the process may be repeated for the next print run. It is preferable that the sprayed polymer contains all of the imaging and printing properties in a single coating.

Yu in WO 02/051636 A1 describes an invention and notes the history of its development whereby an infrared sensitive water-based emulsion is applied to a hydrophilic substrate, dried by evaporation of the water and imaged. Imaging is by emulsion coalescence, which produces insoluble oleophilic regions. Processing is done using the fount to remove the uncoalesced, unimaged areas on press. Such a method contaminates the fount solution, which in general in offset lithographic printing is carefully controlled to give optimum print quality and machine runability.

Zheng et al (U.S. Pat. No. 6,413,694) describes switchable polymer layers whereby oleophilic layers are switched to hydrophilic surfaces, thus describing a positive working switchable polymer plate. In US2002/0142245 A1, Zheng describes the opposite type of switching from hydrophilic to hydrophobic. Examples given in this patent show the utilization of special syntheses to produce key materials for the invention.

Morgan (U.S. Pat. No. 6,063,528) describes switchable polymer layers whereby hydrophilic layers containing a metallic salt of a fatty acid such as silver behenate and a water-soluble polymer, as well as infrared absorbable dyes, are switched by imaging to oleophilic surface areas. The use of silver in the plate makes it relatively expensive.

### SUMMARY OF THE INVENTION

It is an objective of the invention to produce mixtures that can be applied to substrates to produce infrared sensitive layers with hydrophilic surfaces, which may be switched by image-wise exposure in an infrared imaging plate-setter to give oleophilic printing areas.

Thus, there is provided a mixture for producing infra-red sensitive layers with hydrophilic surfaces, which may be switched by image-wise exposure to give oleophilic printing areas, comprising: polyacrylic acid; polyvinyl alcohol; aminoplast cross-linking agent; infrared sensitive dye or pigment; and acidic hydrophobic polymeric emulsion, wherein said mixture is deposited from an aqueous carrier liquid.

The mixture may additionally comprise at least one of wetting agents, fillers and exotherms.

In one embodiment of the present invention, the polyacrylic acid and the polyvinyl alcohol comprise together between 20% and 58% of the total solids of the mixture.

In another embodiment of the present invention, the polyvinyl alcohol comprises less than 15% of the total solids of the polyacrylic acid.

In another embodiment of the present invention, the aminoplast resin is water-soluble.

In another embodiment of the present invention, the aminoplast resin provides crosslinking of the polyacrylic and polyvinyl alcohol resins to help insolublize them.

In an additional embodiment of the present invention, the mixture does not contain catalysts for the cross-linking process involving the aminoplast.

In another embodiment of the present invention, the aminoplast does not exceed 40% of the polyvinyl alcohovpolyacrylic acid mixture.

The aminoplast may be methyl methylol urea.

The dye may be water-soluble.

In yet another embodiment of the present invention, the infrared absorbing pigment comprises water-dispersed carbon black and the dyes dissolve in water miscible solvents.

It is a further objective of the invention to produce an offset lithographic printing blank using raw materials that are readily available and can be purchased off the shelf and do not require costly synthesis.

It is a further objective of the invention to produce an offset lithographic printing plate which after imaging requires no further treatment before printing.

It is a further objective of the invention to produce an offset lithographic printing plate that after imaging and when placed on a printing press does not require the fount to wash away the background coating of the plate.

It is a further objective of the invention to produce mixtures which can be applied as a single coat to produce switchable polymer offset lithographic plates that can be imaged in an infrared laser plate-setter.

It is a further objective of the invention to provide aqueous mixtures of switchable polymer material that can be applied to the surface of a cylinder of a printing press, the water evaporated off on-press, imaged, printed and then the coating completely removed and a further cycle done to constitute a plateless system.

Thus, there is provided a method of producing a processless offset lithographic printing plate, comprising the steps of: providing a mixture comprising polyacrylic acid; polyvinyl alcohol; aminoplast cross-linking agent; infrared sensitive dye or pigment; and acidic hydrophobic polymeric emulsion, said mixture deposited from an aqueous carrier; applying a layer of the mixture onto a substrate to produce an infra-red sensitive layer with a hydrophilic surface; drying the applied layer; and switching the hydrophilic surface by image-wise exposure to infrared imaging to give oleophilic printing areas.

The substrate may comprise an offset lithographic printing plate precursor or the surface of a printing press cylinder.

The mixture may additionally comprise at least one of wetting agents, fillers and exotherms.

According to one embodiment of the present invention, the polyacrylic acid and the polyvinyl alcohol comprise together between 20% and 58% of the total solids of the mixture.

According to another embodiment of the present invention, the polyvinyl alcohol comprises less than 15% of the total solids of the polyacrylic acid.

According to another embodiment of the present invention, the aminoplast resin is water-soluble.

According to yet another embodiment of the present invention, the aminoplast resin provides crosslinking of the polyacrylic and polyvinyl alcohol resins to help insolublize them.

According to yet another embodiment of the present invention, the mixture does not contain catalysts for the cross-linking process involving the aminoplast.

According to yet another embodiment of the present invention, the aminoplast does not exceed 40% of the polyvinyl alcohol/polyacrylic acid mixture.

The aminoplast may be methyl methylol urea.

The dye may be water-soluble.

The infrared absorbing pigment may comprise water-dispersed carbon black.

### DETAILED DESCRIPTION OF THE INVENTION

The mixtures used in this invention are all aqueous based. The aqueous solution used in this invention contains a number of essential components. These are as follows:

1. Polyacrylic acid

2. Polyvinyl alcohol

3. Aminoplast cross-linking agent.

4. Infrared sensitive dye or pigment.

5. Acidic polymeric emulsion.

6. There are also optional additional ingredients such as wetting agents, fillers and exotherms.

It is important also to emphasize that the mixtures must not contain catalysts for the cross-linking process involving the aminoplast.

The type of substrate coating used is described in co-pending U.S. Provisional Application No. 60/444,183 entitled CTP-Inkjet Using Switchable Polymer, commonly owned with the present application and hereby incorporated by reference. The polyacrylic acid and the polyvinyl alcohol comprise the water-soluble elements of the formulation that provide the hydrophilic nature of the coating. These together must constitute between 20% and 58% of the total solids of the mixture as applied to the substrate. The polyvinyl alcohol must be less than 15% (weight of solids) of the polyacrylic acid. The aminoplast resin must be a water-soluble one and when the coating is dried probably provides some crosslinking of the polyacrylic and polyvinyl alcohol resins to help insolublize them. However, whilst aminoplasts are not generally used without a catalyst which may be, for instance a sulfonic acid, in this system no catalyst must be present. In trials using such catalysts it was found that drying temperature was critical in achieving the balance of water resistance of the coating against hydrophobic properties. In such formulations, it was found that it is not possible to achieve complete water resistance and hydrophilic properties merely by the balance between the polyacrylic/polyvinyl alcohol mixture and the aminoplast. Too much aminoplast or too high a drying temperature causes sufficient cross-linking to turn the entire coating oleophilic. Too little aminoplast and too low a drying temperature causes the coating to be water soluble and consequently the fount will remove the entire coating during the printing process. Without the presence of the catalyst and in the formulations as described in this application, it was possible to achieve excellent hydrophilic properties together with excellent water resistance and adhesion to substrate, where the finished formulation is subject to sufficient heating.

The aminoplast must not exceed 40% of the polyvinyl alcohol/polyacrylic acid mixture, otherwise the dried coating will lose its hydrophilicity. An examples of a suitable aminoplast is methyl methylol urea. Also, it has been found that it is essential to incorporate an acidic water-resistant water-based emulsion into the formulation. It is somewhat unexpected that such a material can be used without ruining the surface hydrophilic properties of the coating whilst giving fount-resisting properties. It is not clear whether the excellent adhesion of the layer to the substrate and resistance to fount attack is a result of the presence of the hydrophilic emulsion or of some uncatalysed crosslinking that may take place between the aminoplast and the —OH groups from the polyvinyl alcohol and the polyacrylic acid.

Switching of the coating from being hydrophilic to oleophilic occurs in the image areas when they are subject to the heat produced by laser imaging. It is most likely that this occurs by heat initiated cross-linking between the aminoplast and other ingredients.

Suitable infrared dyes and pigments are those known to the art. These may be used individually or in mixtures. The preferred type of dye is that which is water-soluble and examples of such dyes are water-soluble nigrosine, ADS830W (sold by American Dye Source Incorporated, Quebec, Canada) and NK 5042 (sold by Hayashibara Biochemical laboratories, Kakoh-Shikiso Institute, Okayama, Japan). However, it is also possible to use water dispersed carbon black and dyes dissolved in water miscible solvents, such as alcohol, and then added to form a solution or dispersion into the aqueous mixture.

The following example is given to illustrate the invention.

### EXAMPLE I

The following formulation was made up—all quantities are in parts by weight. All of the ingredients shown below are readily available and can be purchased off the shelf.

| | | |
|---|---|---|
| Polyvinyl Alcohol Solution | 7.2 | grams |
| (12% in water) | | |
| Polyacrylic Acid | 18.4 | grams |
| (35% solution in water) | | |
| Deionised water | 71 | grams |
| BYK 346 | 1.9 | grams |
| Walpol 40-136 | 25.15 | grams |
| Cymel UFR-60 | 2.04 | grams |
| Nigrosine | 1.8 | grams |

The mixture was high-speed mixed and coated with a Mayer rod onto 150 micron thick degreased aluminum foil. It was dried in an oven at 160° C. for 4 minutes and had a coating weight of approximately 7 grams per square meter. The finished plate was then imaged at approximately 900 milli-joules per square centimeter on a Creo Lotem Flexo plate-setter. The imaged plate was taken directly from the plate-setter and mounted directly onto a Heidelberg GTO offset lithographic printing press and 8000 good printing impressions run off using the conventional wet offset process.

In addition, the above formulation can be sprayed onto an aluminum surface of a plate cylinder in a printing press and the coating dried and fused onto the surface at 160° C. and then imaged and used for printing as described by Gelbart in U.S. Pat. No. 5,713,287, which is co-owned and incorporated herein by reference.

Sources of Raw Materials

BYK 346. BYK-Chemie GmbH, Posffach 100245, Wesel

Cymel UFR-60 Cytec Industries. Five Garret Mountain Plaza, West Patterson, N.J. USA

Walpol 40-136. Reichold, Inc, Research Triangle Park, N.C., USA.

1. A mixture for producing infra-red sensitive layers with hydrophilic surfaces, which may be switched by image-wise exposure to give oleophilic printing areas, comprising:
polyacrylic acid;
polyvinyl alcohol;
aminoplast cross-linking agent;
infrared sensitive dye or pigment; and
acidic hydrophobic polymeric emulsion,
wherein said mixture is deposited from an aqueous carrier liquid.

2. The mixture of claim 1, additionally comprising at least one of wetting agents, fillers and exotherms.

3. The mixture of claim 1, wherein the polyacrylic acid and the polyvinyl alcohol comprise together between 20% and 58% of the total solids of the mixture.

4. The mixture of claim 1, wherein the polyvinyl alcohol comprises less than 15% of the total solids of the polyacrylic acid.

5. The mixture of claim 1, wherein the aminoplast resin is water-soluble.

6. The mixture of claim 1, wherein the aminoplast resin provides crosslinking of the polyacrylic and polyvinyl alcohol resins to help insolublize them.

7. The mixture of claim 1, wherein the mixture does not contain catalysts for the cross-linking process involving the aminoplast.

8. The mixture of claim 1, wherein the aminoplast does not exceed 40% of the polyvinyl alcohol/polyacrylic acid mixture.

9. The mixture of claim 1, wherein the aminoplast is methyl methylol urea.

10. The mixture of claim 1, wherein the dye is water-soluble.

11. The mixture of claim 1, wherein the infrared absorbing pigment comprises water-dispersed carbon black and wherein the dyes dissolve in water miscible solvents.

12. A method of producing a processless offset lithographic printing plate, comprising the steps of
providing a mixture comprising
polyacrylic acid;
polyvinyl alcohol;
aminoplast cross-linking agent;
infrared sensitive dye or pigment; and
acidic hydrophobic polymeric emulsion, said mixture deposited from an aqueous carrier;
applying a layer of the mixture onto a substrate to produce an infra-red sensitive layer with a hydrophilic surface;
drying the applied layer; and
switching the hydrophilic surface by image-wise exposure to infrared imaging to give oleophilic printing areas.

13. The method of claim 12, wherein said substrate comprises an offset lithographic printing plate precursor.

14. The method of claim 12, wherein said substrate comprises the surface of a printing press cylinder.

15. The method of claim 12, wherein said mixture additionally comprises at least one of wetting agents, fillers and exotherms.

16. The method of claim 12, wherein the polyacrylic acid and the polyvinyl alcohol comprise together between 20% and 58% of the total solids of the mixture.

17. The method of claim 12, wherein the polyvinyl alcohol comprises less than 15% of the total solids of the polyacrylic acid.

18. The method of claim 12, wherein the aminoplast resin is water-soluble.

19. The method of claim 12, wherein the aminoplast resin provides crosslinking of the polyacrylic and polyvinyl alcohol resins to help insolublize them.

20. The method of claim 12, wherein the mixture does not contain catalysts for the cross-linking process involving the aminoplast.

21. The method of claim 12, wherein the aminoplast does not exceed 40% of the polyvinyl alcohol/polyacrylic acid mixture.

22. The method of claim 12, wherein the aminoplast is methyl methylol urea.

23. The method of claim 12, wherein the dye is water-soluble.

24. The method of claim 12, wherein the infrared absorbing pigment comprises water dispersed carbon black.
